(19) United States
(12) Patent Application Publication
(10) Pub. No.: US 2005/0132363 A1
(43) Pub. Date: Jun. 16, 2005

(54) Method, apparatus and system for optimizing context switching between virtual machines

(76) Inventors: Vijay Tewari, Portland, OR (US); Robert C. Knauerhase, Portland, OR (US); Milan Milenkovic, Portland, OR (US)

Correspondence Address: INTEL CORPORATION, P.O. BOX 5326, SANTA CLARA, CA, 95056-5326, US

(21) Appl. No.: 10/738,521

(22) Filed: Dec. 16, 2003

(51) Int. Cl. G06F 9/455

(52) U.S. Cl. 718/1

(57) ABSTRACT

A method, apparatus and system may optimize context switching between virtual machines (“VMs”). According to an embodiment of the present invention, a first processor core may execute a first VM while a second processor core may concurrently retrieve information pertaining to the state of a second VM into a processor cache. When the virtual machine manager (“VMM”) performs a context switch between the first and the second VMs, the second processor may immediately begin executing the second VM, while the first processor may save the state information for the first VM. In yet another embodiment, different threads on a processor may be utilized to execute different VMs on a host.

### CROSS-REFERENCE TO RELATED APPLICATION

The present application is related to co-pending U.S. patent application Ser. No. ______, entitled “Method, Apparatus and System for Optimizing Context Switching Between Virtual Machines,” Attorney Docket Number P18449, assigned to the assignee of the present invention (and filed concurrently herewith).

### FIELD

The present invention relates to the field of virtualization, and, more particularly to a method, apparatus and system for optimizing context switching between virtual machines.

### BACKGROUND

Virtualization technology enables a single host running a virtual machine monitor (“VMM”) to present multiple abstractions of the host, such that the underlying hardware of the host appears as one or more independently operating virtual machines (“VMs”). Each VM may therefore function as a self-contained platform, running its own operating system (“OS”), or a copy of the OS, and/or a software application. The operating system and application software executing within a VM is collectively referred to as “guest software.” The VMM performs “context switching” as necessary to multiplex between various virtual machines according to a “round-robin” or some other predetermined scheme. To perform a context switch, the VMM may suspend execution of a first VM, optionally save the current state of the first VM, extract state information for a second VM and then execute the second VM.

### BRIEF DESCRIPTION OF THE DRAWINGS

The present invention is illustrated by way of example and not limitation in the figures of the accompanying drawings in which like references indicate similar elements, and in which:

FIG. 1 illustrates conceptually an example multi-core processor according to embodiments of the present invention;

FIG. 2 illustrates conceptually the various threads in a hyperthreaded processor according to an embodiment of the present invention; and

FIG. 3 is a flowchart illustrating an embodiment of the present invention.

### DETAILED DESCRIPTION

Embodiments of the present invention provide a method, apparatus and system for optimizing context switching between VMs. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

The VMM on a virtual machine host has ultimate control over the host's physical resources and, as previously described, the VMM allocates these resources to guest software according to a round-robin or some other scheduling scheme. Current VMM's rely on the same execution thread (e.g., a hardware thread, a processor core and/or a central processing unit) to perform context switching (i.e., to save/restore the state of virtual machines) and to run the virtual machines. Currently, when the VMM schedules another VM for execution, it suspends execution of the active VM, and restores the state of a previously suspended VM from memory and/or disk into the processor cache, then resumes execution of the newly restored VM. It may also save the execution state of the suspended VM from the processor cache into memory and/or disk. The VMM typically uses the same execution thread to save the execution state (i.e., the internal state of the processor cache when the current VM was context switched out, including the paging data structure, device state, program counters, stack pointers, etc.) of the current VM from the host's processor cache to a main storage location, such as memory and/or disk. The previously suspended state of a second virtual machine from main memory and/or disk is brought into the host's processor cache and the second virtual machine is allowed to execute. Storing and retrieving state information to and from memory and/or disk, and use of the same execution thread to perform all such tasks is a virtualization overhead that may result in delays that significantly degrade the host's overall performance and the performance of the virtual machines.

Embodiments of the present invention include an optimized method, apparatus and system for context switching between VMs. More specifically, embodiments of the present invention optimize the context switching between virtual machines by using a separate execution thread to restore the state of a new VM in parallel while the VMM is running the previous VM (i.e., using a different execution thread). As used herein, an execution thread may include a separate process on a host, a separate thread and/or a separate processor core on a multi-core processor. “Multi-core processors” are well known to those of ordinary skill in the art and include a chip that contains more than one processor core. Embodiments of the present invention may be implemented as software, hardware, firmware and/or as a combination thereof. For example, the VMM may be implemented as a software application, or device driver, or as part of the operating system, or as part of or embedded in a chipset or microprocessor, or as a combination thereof.

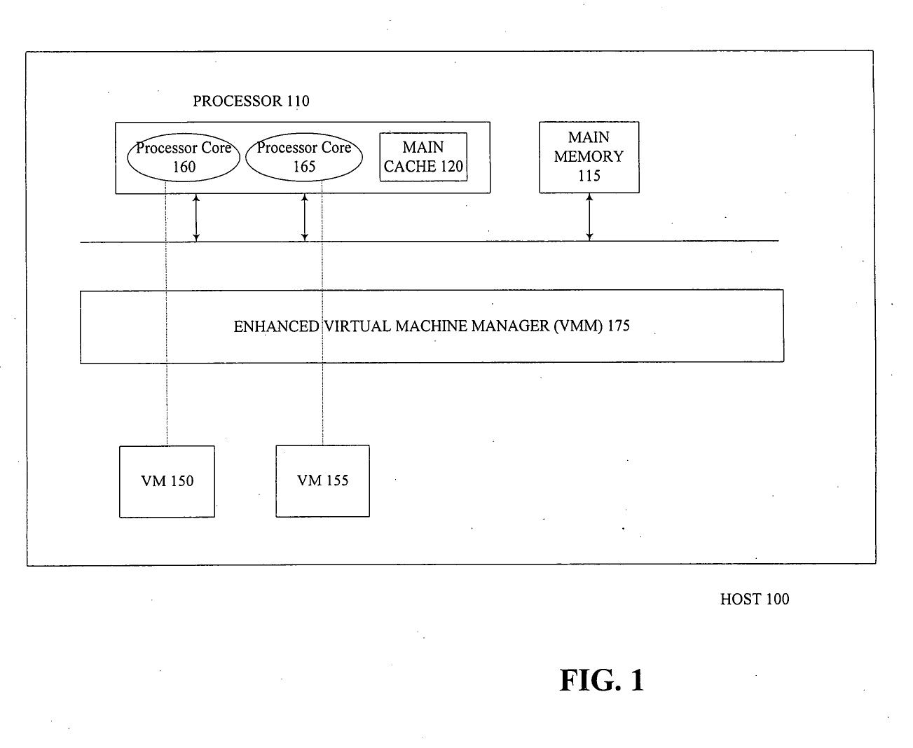

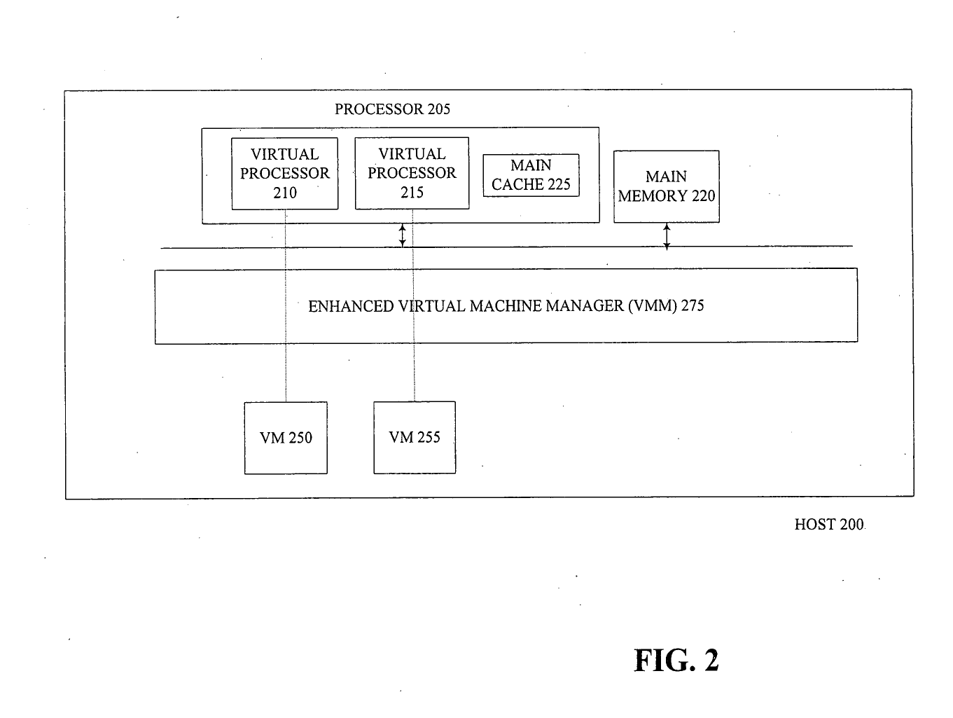

FIG. 1 and FIG. 2 illustrate various embodiments of the present invention. In one embodiment, a hardware solution may include the use of a multi-core processor. FIG. 2 illustrates an example multi-core processor according to embodiments of the present invention. In this example, Host 100 may include Processor 110 which includes Main Cache 120, Processor Core 160 and Processor Core 165, and Main Memory 115. Although only two processor cores are illustrated, it will be readily apparent to those of ordinary skill in the art that multi-core processors may include additional cores. Host 100 may also be executing various virtual machines (“VM 150”-“VM 165”) managed by Enhanced VMM 175. In this embodiment, while Processor Core 160 executes VM 150, Enhanced VMM 175 may activate Processor Core 165 to take appropriate action to restore the state of VM 155, including appropriately inserting data into Main Cache 120. Thus, while Processor Core 160 continues to access Main Cache 120 for information pertaining to VM 150, Processor Core 165 may be loading VM 155 state information into the same cache. The process of managing the information in Main Cache 120 from various processors is well known to those of ordinary skill in the art and further description thereof is omitted herein. When Enhanced VMM 175 performs the context switch, Processor Core 160 may immediately begin running VM 155 because Main Cache 120 already includes at least some state information necessary to run VM 155.

In yet another embodiment, a hyperthreaded processor may be used to optimize context switching between virtual machines. Hyperthreaded processors (e.g., (Intel Corporation's Pentium® 4 Processor with Hyper-Threading Technology) are well known to those of ordinary skill in the art and include a single physical processor with multiple logical processors, each sharing the physical resources of the host. FIG. 2 illustrates conceptually the various threads in a hyperthreaded processor according to an embodiment of the present invention. According to this embodiment, the threads on the hyperthreaded processor essentially represent virtual processors that enable separate execution threads to run the various virtual machines, and to store and/or restore the state information pertaining to various virtual machines. As illustrated, Host 200 may include hyperthreaded processor 205, capable of multiple execution threads (illustrated as “Virtual Processor 210” and “Virtual Processor 215”), Main Memory 220 and Main Cache 225. Although only two threads (i.e., virtual processors) are illustrated, it will be apparent to those of ordinary skill in the art that hyperthreaded processors may include additional threads. Host 200 may additionally include multiple virtual machines (illustrated as “VM 250” and “VM 255”), managed by Enhanced VMM 275.

According to one embodiment, each thread on Host 200 may be assigned to a virtual machine. Thus, for example, Thread 205 may execute VM 250 while Thread 210 may execute VM 255. In this embodiment, when Enhanced VMM 275 determines that it needs to perform a context switch from VM 250 to VM 255, it may activate Thread 210 to begin retrieving state information for VM 255 into Main Cache 225. Upon the context switch, Thread 205 may save the state information for VM 250 while Thread 210 begins execution of VM 255 using the state information already loaded into Main Cache 225.

Although specific embodiments have been described in detail above, any of the above-described embodiments may be practiced separately or in combination, to achieve the same result. It will be readily apparent to those of ordinary skill in the art that these combinations of features may be practiced in various embodiments to further optimize context switching between VMs.

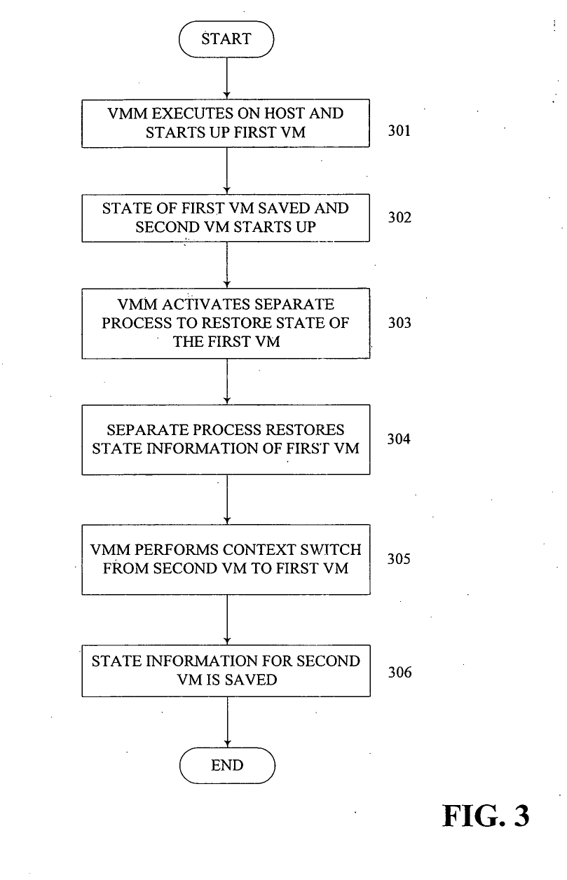

FIG. 3 is a flow chart of an embodiment of the present invention. Although the following operations may be described as a sequential process, many of the operations may in fact be performed in parallel and/or concurrently. In addition, the order of the operations may be re-arranged without departing from the spirit of embodiments of the invention. In 301, a VMM may execute on a virtual machine host and start up a first VM. The state of the first VM may be saved when the VMM executes a second VM on the host in 302. In 303, the VMM may determine to context switch from the second VM back to the first VM and therefore activate a separate process to restore the state of the first VM. In 304, the separate process may restore the state of the first VM, including inserting appropriate data in the host's processor cache. In 305, the VMM may perform a context switch from the second VM to the first VM, and the state information of the second VM may then be saved concurrently while the first VM is running in 306.

The hosts according to embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. As previously described, these computing devices may include multi-core processors and/or hyperthreaded processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the computing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method of optimizing context switching between virtual machines, comprising:
executing a first virtual machine utilizing state information for the first virtual machine contained in a processor cache;
retrieving state information for a second virtual machine while the first virtual machine is executing;
populating the processor cache with the state information for the second virtual machine;
context switching from the first virtual machine to the second virtual machine; and
executing the second virtual machine immediately based on the state information for the second virtual machine in the processor cache and concurrently saving state information for the first virtual machine from the processor cache to a storage location.

2. The method according to claim 1 wherein the second virtual machine is a previously executing virtual machine.

3. The method according to claim 1 wherein executing the first virtual machine further comprises a first process executing the first virtual machine, and retrieving the state information for the second virtual machine further comprises a second process retrieving the state information for the second virtual machine.

4. The method according to claim 3 wherein executing the second virtual machine immediately further comprises the first process executing the second virtual machine immediately based on the state information for the second virtual machine in the processor cache and the second process concurrently saving state information for the first virtual machine from the processor cache to the storage location.

5. The method according to claim 4 wherein the first process and the second process are separate processor cores on a multi core processor.

6. The method according to claim 3 wherein executing the second virtual machine immediately further comprises the second process executing the second virtual machine immediately based on the state information for the second virtual machine in the processor cache and the first process concurrently saving state information for the first virtual machine from the processor cache to the storage location.

7. The method according to claim 6 wherein the first process and the second process are separate threads on a hyperthreaded processor.

8. The method according to claim 1 wherein the storage location is one of a main memory and a hard disk.

9. A system for optimizing context switching between virtual machines, comprising:
a processor including a first process and a second process;
a processor cache coupled to the processor, the processor cache including state information pertaining to a first virtual machine; and
a main storage location including state information for a second virtual machine, the first process capable of executing the first virtual machine utilizing the state information in the processor cache, the second process capable of retrieving the state information for the second virtual machine from the main storage location into the processor cache while the first virtual machine is executing, and upon a context switch, the first process capable of executing the second virtual machine immediately utilizing the retrieved state information for the second virtual machine in the processor cache and the second process capable of storing the state information for the first virtual machine from the processor cache into the main storage location.

10. The system according to claim 9 wherein the second virtual machine is a previously executing virtual machine.

11. The system according to claim 9 wherein the processor is a multi-core processor and first process and the second process comprise a first processor core and a second processor core on the multi-core processor.

12. The system according to claim 9 wherein the main storage includes one of a main memory and a hard disk.

13. A system for optimizing context switching between virtual machines, comprising:
a processor including a first process and a second process;
a processor cache coupled to the processor, the processor cache including state information pertaining to a first virtual machine; and
a main storage location including state information for a second virtual machine, the first process capable of executing the first virtual machine utilizing the state information in the processor cache, the second process capable of retrieving the state information for the second virtual machine from the main storage location into the processor cache while the first virtual machine is executing, and upon a context switch, the second process capable of executing the second virtual machine immediately utilizing the retrieved state information for the second virtual machine in the processor cache and the first process capable of storing the state information for the first virtual machine from the processor cache into the main storage location.

14. The system according to claim 13 wherein the second virtual machine is a previously executing virtual machine.

15. The system according to claim 13 wherein the processor is a hyperthreaded processor and the first process and the second process comprise a first thread and a second thread on the hyperthreaded processor.

16. The system according to claim 13 wherein the main storage includes one of a main memory and a hard disk.

17. An article comprising a machine-accessible medium having stored thereon instructions that, when executed by a machine, cause the machine to:
execute a first virtual machine utilizing state information for the first virtual machine contained in a processor cache;
retrieve state information for a second virtual machine while the first virtual machine is executing;
populate the processor cache with the state information for the second virtual machine;
context switch from the first virtual machine to the second virtual machine; and
execute the second virtual machine immediately based on the state information for the second virtual machine in the processor cache and concurrently saving state information for the first virtual machine from the processor cache to a storage location.

18. The article according to claim 17 wherein the second virtual machine is a previously executing virtual machine.

19. The article according to claim 17 wherein the instructions, when executed by the machine, cause a first process to execute the first virtual machine and a second process to retrieve the state information for the second virtual machine.

20. The article according to claim 19 wherein the instructions, when executed by the machine, further cause the first process to execute the second virtual machine immediately based on the state information for the second virtual machine in the processor cache and the second process to concurrently save state information for the first virtual machine.

21. The article according to claim 19 wherein the first process and the second process are separate processor cores on a multi core processor.

22. The article according to claim 19 wherein the instructions, when executed by the machine, further cause the second process to execute the second virtual machine immediately based on the state information for the second virtual machine in the processor cache and the first process to concurrently save state information for the first virtual machine.

23. The article according to claim 22 wherein the first process and the second process are separate threads on a hyperthreaded processor.

24. The method according to claim 17 wherein the storage location is one of a main memory and a hard disk.

25. A method of optimizing context switching between virtual machines, comprising:
executing a first virtual machine;
suspending execution of the first virtual machine and saving state information for the first virtual machine;
executing a second virtual machine;
retrieving the state information for the first virtual machine into a processor cache while the second virtual machine is executing;
suspending execution of the second virtual machine and immediately executing the first virtual machine utilizing the state information pertaining to the first virtual machine in the processor cache; and
saving state information for the second virtual machine.

26. The method according to claim 25 wherein executing the first virtual machine further comprises a first process executing the first virtual machine and the second virtual machine and a second process suspending execution of the first virtual machine, saving the state for the first virtual machine, retrieving the state of the first virtual machine into the processor cache and saving the state information for the second virtual machine.

27. The method according to claim 26 wherein the first process and the second process are separate processor cores on a multi core processor.

28. The method according to claim 25 wherein executing the first virtual machine further comprises a first process executing the first virtual machine, suspending execution of the first virtual machine, saving the state for the first virtual machine and retrieving the state of the first virtual machine into the processor cache, and a second process executing the second virtual machine and saving the state information for the second virtual machine.

29. The method according to claim 28 wherein the first process and the second process are separate threads on a hyperthreaded processor.
